(19) United States
(12) Patent Application Publication
(10) Pub. No.: US 2009/0032164 A1
(43) Pub. Date: Feb. 5, 2009

(54) Sanitary hose with sealed ends and antimicrobial agent

(75) Inventor: Henry Halimi, Los Angeles, CA (US)

Correspondence Address: EDWARDS ANGELL PALMER & DODGE LLP, P.O. BOX 55874, BOSTON, MA, 02205, US

(73) Assignee: Watts Regulator Company, North Andover, MA (US)

(21) Appl. No.: 12/220,720

(22) Filed: Jul. 28, 2008

Related U.S. Application Data
(60) Provisional application No. 60/953,123, filed on Jul. 31, 2007.

(51) Int. Cl. F16L 11/04; B29C 65/54

(52) U.S. Cl. 156/69; 138/137

(57) ABSTRACT

A reinforced flexible hose extending between a first end and a second end and including a first non-toxic inner layer, a second layer surrounding and reinforcing the first layer, a third layer surrounding the second layer, a fourth layer surrounding and reinforcing the third layer, an outer layer made of plastic or rubber including an antimicrobial agent, and annular caps coating the ends of the flexible hose so that the intermediate layers are fully encapsulated. End connection terminals are attached to the hose ends over the caps.

### CROSS-REFERENCE TO RELATED APPLICATION

This application claims priority to U.S. Provisional Patent Application No. 60/953,123, filed Jul. 31, 2007, which is incorporated herein by reference.

### TECHNICAL FIELD OF THE DISCLOSURE

The present disclosure relates to a flexible hose for use with sanitary appliances and, more particularly, to a multilayer, reinforced flexible hose that can be used to convey potable water. The flexible hose includes sealed ends and an antimicrobial agent (i.e., pesticide). The sealed ends protect the hose reinforcement from contaminants while the antimicrobial agent may reduce or substantially eliminate the growth and proliferation of undesirable microbes.

### BACKGROUND OF THE DISCLOSURE

Flexible hoses are used for connecting sanitary appliances such as sinks, showers, bathtubs, toilets, etc. to the end of fixed potable water supply pipes in homes, restaurants, hospitals, and other buildings. Such flexible hoses often include an inner layer made of a suitable non-toxic material, such as polyvinyl chloride or rubber, and an outer layer made of a durable reinforcing material, such as stainless steel braids. For example, see U.S. Pat. No. 5,884,945 issued on Mar. 23, 1999 to Bader et al. In FIG. 1 of Bader et al., a flexible sanitary hose 1 has an end 2 with a threaded nipple 4, which is attached to the hose 1 by a crimping collar 9. The hose body includes a rubber hose 12 that is reinforced with metal braid 13, which is surrounded by an encasing tube 14 that also extends over the crimping collar 9. The encasing tube 14 protects the metal braid 13 from dirt and other contaminants, which can collect in the braiding and provide a breeding ground for microbes.

What is still desired is a new and improved flexible hose for use with sanitary appliances that is flexible, yet is strong and durable through the use of a braided reinforcing layer. Preferably, the hose will include an outer layer for protecting the braided reinforcement from contaminants and that will reduce or substantially eliminate the growth and proliferation of microbes including but not limited to bacteria, algae, mold, and fungi.

### SUMMARY OF THE DISCLOSURE

Exemplary embodiments of the present disclosure provide a reinforced flexible hose having at least three layers: a non-toxic plastic or rubber inner layer that is suitable for transporting potable water, an intermediate braided layer for providing the hose with add strength and durability, and an outer layer made of plastic or rubber including an antimicrobial agent. End connection terminals are attached to the hose ends.

According to one aspect of the disclosure, the hose further includes annular caps coating ends of the hose so that the braided layer is fully encapsulated. The caps are located between the ends of the hose and the connection terminals.

In one embodiment, the subject disclosure is directed to a reinforced flexible hose extending between a first end and a second end and including a first non-toxic inner layer, a second layer surrounding and reinforcing the first layer, a third layer surrounding the second layer, a fourth layer surrounding and reinforcing the third layer, an outer layer made of plastic or rubber including an antimicrobial agent, and annular caps coating the ends of the flexible hose so that the intermediate layers are encapsulated. End connection terminals are attached to the hose ends over the caps.

In a further embodiment, the subject disclosure is directed to a flexible hose having a first end and a second end including an inner non-toxic inner layer, at least one intermediate layer surrounding the inner layer, an outer layer surrounding the intermediate layer, and annular caps coating the ends of the flexible hose so that the at least one intermediate layer is fully encapsulated.

The subject disclosure is also directed to a method of fabricating a hose assembly including the steps of providing a hose having a non-toxic inner layer, at least one middle layer surrounding the inner layer, and an outer layer surrounding the middle layer, protecting the outer layer with a pesticide, such as an antimicrobial agent, and sealing at least one end of the hose with an annular cap to protect the at least one middle layer from fluid and corrosion. The method may further comprise the steps of protecting the end layer with an antimicrobial agent, and protecting the inner layer with an antimicrobial agent. According to one aspect, the cap is formed by dipping the end of the hose in molten material, such as a plastic, and allowing the molten material to harden. According to another aspect, the method further includes attaching a connection terminal over the capped end.

Additional aspects and advantages of the present disclosure will become readily apparent to those skilled in this art from the following detailed description, wherein only exemplary embodiments of the present disclosure are shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF DRAWINGS

Reference is made to the attached drawings, wherein elements having the same reference character designations represent like elements throughout, and wherein:

FIG. 1 is a perspective view of a sink assembly partially cut-away to illustrate water hose assemblies constructed in accordance with the present disclosure, wherein the hose assemblies are shown coupled to a faucet assembly and a drain of the sink assembly;

FIG. 2 is an elevation view of one of the hose assemblies of FIG. 1, wherein the hose assembly includes a reinforced flexible hose extending between connection terminals;

FIG. 3 is an enlarged, cut-away view of the hose of the hose assembly of FIG. 1;

FIG. 4 is an enlarged, exploded sectional view of the hose and the connection terminal of the hose assembly of FIG. 1.

### DETAILED DESCRIPTION OF AN EXEMPLARY EMBODIMENT

The present disclosure provides a new and improved reinforced flexible sanitary water hose assembly that overcomes many of the problems associated with prior art sanitary hose assemblies. The advantages, and other features of the hose assembly disclosed herein, will become more readily apparent to those having ordinary skill in the art from the following detailed description of certain exemplary embodiments taken in conjunction with the drawings.

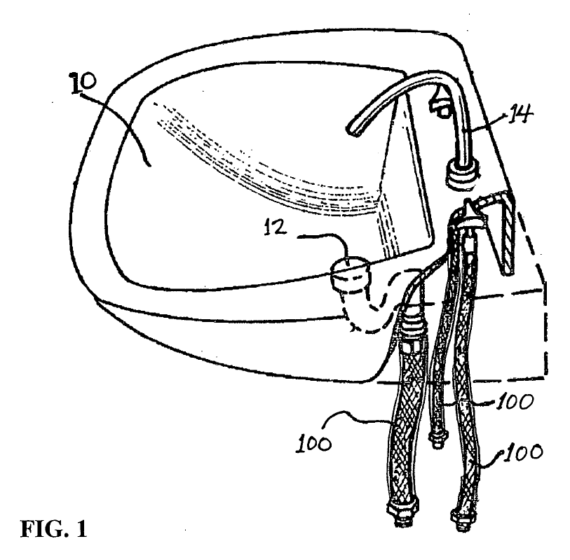

Referring now to the detailed drawings, FIG. 1 shows an exemplary embodiment of a sanitary water hose assembly 100 constructed in accordance with the present disclosure. As illustrated in FIG. 1, the hose assembly 100 is adapted for use with sanitary appliances, such as a sink assembly 10. The hose assembly 100 can be provided in different sizes, such as a larger diameter for connection to a drain 12 of the sink assembly 10 and smaller diameter connectors 100 for connection to a faucet assembly 14 of the sink assembly 10.

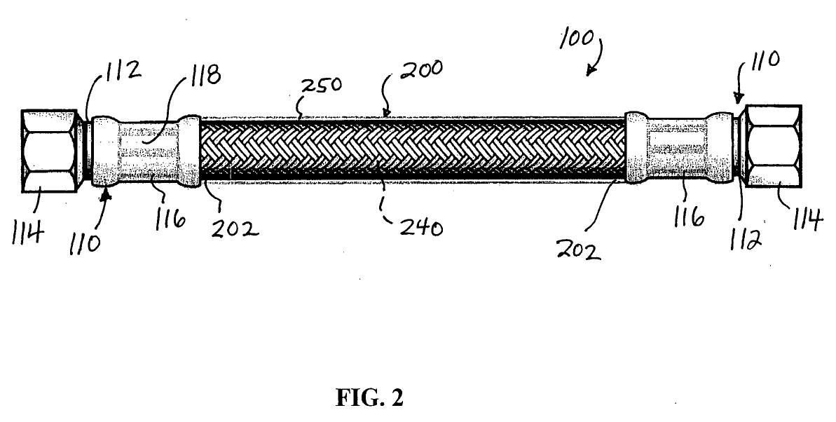

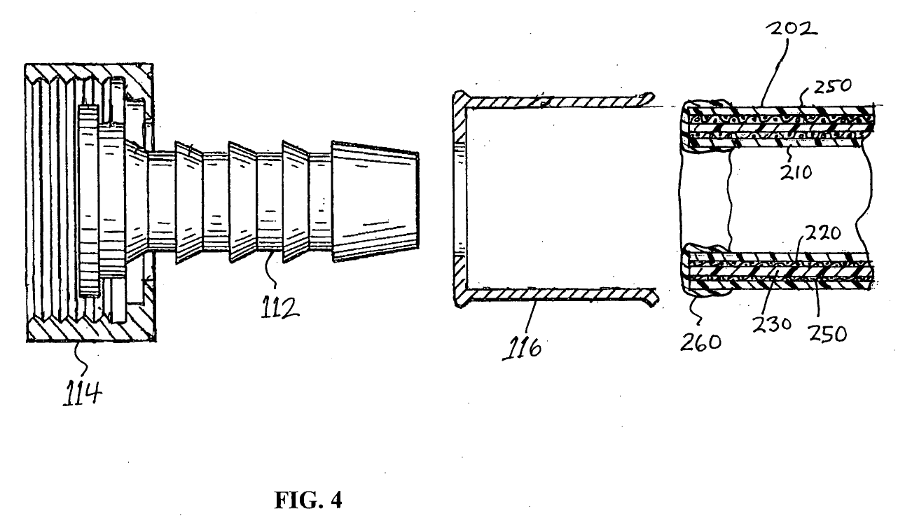

Referring to FIG. 2, an elevation view of a hose assembly 100 is shown. The hose assembly 100 includes a reinforced flexible hose 200 extending between connection terminals 110. In the exemplary embodiment shown, the connection terminals 110 comprise a swivel nut connector 114 having a hose barb 112 (best seen in FIG. 4). The hose barb 112 is received into ends 202 of the hose 200 to provide a fluid tight connection. A ferrule 116 is received over the hose end 202 and crimped to secure the hose end 202 between the ferrule 116 and the barb 112. As can be seen, the ferrule 116 forms indentations 118 when crimped and would typically permanently connect the hose 200 to the connection terminal 110.

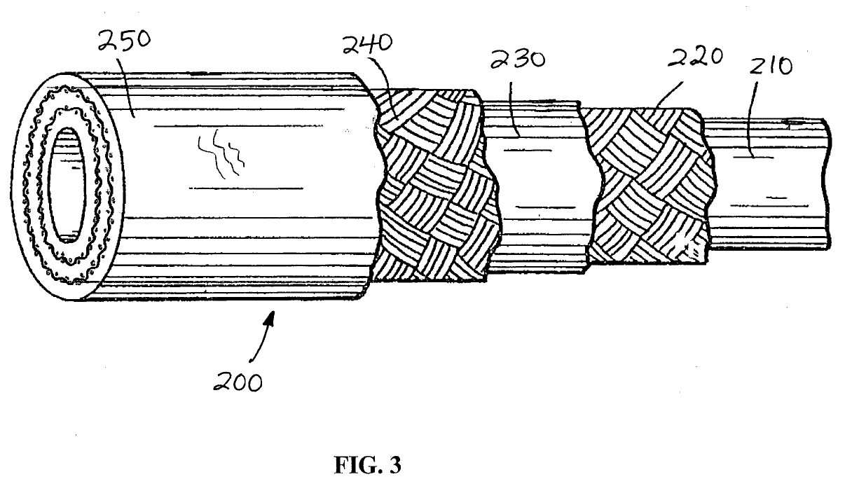

Referring to FIG. 3, an enlarged, cut-away view of the hose 200 of the hose assembly 100 is shown. In this embodiment, the reinforced flexible hose 200 includes five layers: a non-toxic plastic or rubber inner layer 210, a first braided layer 220, a middle layer 230 comprised of plastic or rubber, a second braided layer 240, and an outer layer 250 comprised of plastic or rubber. In another embodiment, the hose 200 has-the inner and outer layers 210, 250 as well as any number of braided middle layers 220, 240.

In one embodiment, the inner layer 210, the middle layer 230, and the outer layer 250 are comprised of polyvinyl chloride (PVC), rubber and combinations thereof. The first braided layer 220 comprises polyester yarn, and the second braided layer 240 comprises stainless steel wire. The braided layers 220, 240 could be the same or any other combination using polyester, metal and the like. As shown in FIGS. 1 and 2, the outer layer 250 of PVC is preferably transparent such that the second braided layer 240 of stainless steel is visible for inspection there through. According to one exemplary embodiment, the inner layer 210 may include an agent or additive that reduces or substantially eliminates the growth and proliferation of microbes as well as providing effective deterrence of pest infestation. The outer layer 250 may also include such and an agent or additive. The agent or additive may be a pesticide, such as an antimicrobial agent, designed to prevent the growth and proliferation of microbes including but not limited to bacteria, algae, mold, and fungi, and even prevent pest infestation. The pesticide may also be held with a binder for release over a period of time.

A suitable antimicrobial agent may be selected from the group consisting of organic antimicrobial agents and metallic antimicrobial agents. Suitable metallic antimicrobial agents include metallic ions such as silver and copper. Zeolites containing silver are a suitable metallic antimicrobial agent. Suitable organic antimicrobial agents include those commonly referred to as chlorinated phenols. 2,4,4′-trichloro-2′hydroxy diphenol ether (also known as triclosan) and 5-chloro-2 phenol (2,4-dichlorophenoxy) are two common chlorinated phenols that are suitable, either individually or in combination. A concentration of the antimicrobial agent between about 200 ppm and 10,000 ppm would be suitable for most applications. As a result, germs, bacteria, microbes, and/or insects may be deterred from contaminating or otherwise undesirably impacting performance of the hose assembly 100.

Referring to FIG. 4, an enlarged, exploded sectional view of the hose 200 and the connection terminal 110 of the hose assembly 100 is shown. Before assembly, each end 202 of the hose 200 is sealed with a cap 260 to provide additional protection to the intermediate layers 220, 230, 240. The cap 260 is annular and only covers the layers 210-250, yet does not block fluid flow through the hose 200. As a result, the intermediate layers 220, 230, 240 will be protected from fluid, dirt, contaminates, and corrosion. The metal braid 240 is particularly in need of protection from fluid and corrosion. Preferably, the intermediate layers 220, 230, 240 are hermetically sealed between the inner and outer layers 210, 250 and the annular caps 260.

The ends 202 may be dipped into molten plastic, which is then allowed to dry to form the caps 260 prior to attachment of the capped ends to the connection terminals 210. The caps 260 may be made from plastic, rubber, or the like. According to one exemplary embodiment, the caps 260 are made from the same material as the outer layer 250, e.g., PVC having an antimicrobial agent.

Once the caps 260 are formed, an antimicrobial agent may be added as a coating onto the inner layer 210, the caps 260, and/or the outer layer 250 to prevent bacterial growth, insect infestation and the like. Alternatively, the layers 210, 250, 260 may have the antimicrobial agent formulated in the plastic or rubber. Upon readying the hose 200, a connection terminal 110 may be attached thereto.

To attach the connection terminal 110, the end 202 of the hose 200 is passed through the ferrule 116 and onto the barb 112. The barb 112 is sized and configured to provide a snug, fluid-tight fit but to insure a permanent attachment, a length of the barb 112 is sufficient to allow crimping of the ferrule 116 thereon. By crimping the ferrule 116 over the end 202 and onto the barb 112, the end 202 of the hose 200 is permanently captured between the barb 112 and crimped ferrule 116. In an alternative embodiment, a hose clamp may be used instead of a crimped ferrule.

In view of the above, the present disclosure provides a new and improved reinforced flexible hose for use with sanitary appliances. The hose assembly 100 will be clean because of the antimicrobial agent in and/or on the inner layer 210, outer layer 250, the caps 260 and combinations thereof. The hose assembly 100 will also be strong and durable because the inner layers 220, 230, 240 are protected from corrosion by the caps 260.

It should be understood that the exemplary embodiments described in this specification have been presented by way of illustration rather than limitation, and various modifications, combinations and substitutions may be effected by those skilled in the art without departure either in spirit or scope from this disclosure in its broader aspects as defined by the appended claims.

All relative descriptions herein such as inner, outer, left, right, up, and down are with reference to the Figures, and not meant in a limiting sense. Unless otherwise specified, the illustrated embodiments can be understood as providing exemplary features of varying detail of certain embodiments, and therefore, unless otherwise specified, features, components, modules, elements, and/or aspects of the illustrations can be otherwise combined, interconnected, sequenced, separated, interchanged, positioned, and/or rearranged without materially departing from the disclosed systems or methods. Additionally, the shapes and sizes of components are also exemplary and unless otherwise specified, can be altered without materially affecting or limiting the disclosed technology. All patents, published patent applications and other references disclosed herein are hereby expressly incorporated in their entireties by reference.

What is claimed is:

1. A reinforced flexible hose having a first end and a second end comprising:
a first non-toxic inner layer;
a second layer surrounding and reinforcing the first layer;
a third layer surrounding and reinforcing the second layer;
a fourth layer surrounding and reinforcing the third layer;
an outer layer made of plastic or rubber including a pesticide; and
annular end caps coating the ends of the flexible hose so that the intermediate layers are encapsulated.

2. A flexible hose as recited in claim 1, wherein the first, third and fifth layers are selected from the group consisting of plastic, rubber and combinations thereof, and the second and fourth layers are braided sheaths.

3. A flexible hose as recited in claim 1, wherein the second layer is fabricated from polyester and the fourth layer is fabricated from metal.

4. A flexible hose as recited in claim 1, whereing the pesticide is selected from the group consisting of organic antimicrobial agents, metallic antimicrobial agents and combinations thereof.

5. A flexible hose as recited in claim 1, wherein the cap is made from a same material as the outer layer.

6. A flexible hose as recited in claim 1, wherein the cap is made from polyvinyl chloride having an antimicrobial agent.

7. A flexible hose as recited in claim 1, further comprising a connection terminal attached to each end of the hose by a crimped ferrule.

8. A flexible hose comprising:
an inner non-toxic inner layer;
at least one middle layer surrounding the inner layer; and
an outer layer surrounding the middle layer, wherein the outer layer includes a pesticide.

9. A flexible hose as recited in claim 8, wherein the hose has at least one end coated with an annular cap to seal the at least one middle layer.

10. A flexible hose as recited in claim 9, further comprising a connection terminal attached to each end of the hose over the caps by a crimped ferrule.

11. A flexible hose as recited in claim 10, wherein the at least one middle layer includes a rubber layer and a braided metal layer.

12. A flexible hose having a first end and a second end comprising:
an inner non-toxic inner layer;
at least one intermediate layer surrounding the inner layer;
an outer layer surrounding the intermediate layer; and
annular caps coating the ends of the flexible hose so that the at least one intermediate layer is encapsulated.

13. A flexible hose as recited in claim 12, wherein at least one of the inner layer, the outer layer, and the caps includes an antimicrobial agent.

14. A flexible hose as recited in claim 12, further comprising a connection terminal attached to each end of the hose over the caps by a crimped ferrule.

15. A flexible hose as recited in claim 12, wherein the at least one intermediate layer includes a rubber layer and a braided layer, wherein the braided layer is fabricated from a material selected from the group consisting of metal, polyester and combinations thereof.

16. A method of fabricating a hose assembly comprising the steps of:
providing a hose having a non-toxic inner layer, at least one middle layer surrounding the inner layer, and an outer layer surrounding the middle layer;
protecting the outer layer with a pesticide; and
sealing at least one end of the hose with an annular cap to protect the at least one middle layer from fluid and corrosion.

17. A method as recited in claim 16, further comprising the step of protecting the cap with a pesticide in a slow release binder, wherein the cap is made from a same material as the outer layer.

18. A method as recited in claim 16, wherein the outer layer is polyvinyl chloride having an antimicrobial agent therein.

19. A method as recited in claim 16, further comprising the step of protecting the inner layer with an antimicrobial agent.

20. A method as recited in claim 16, further comprising the step of attaching a connection terminal to the at least one end over the cap using a ferrule.
